(19) United States
(12) Patent Application Publication
(10) Pub. No.: US 2003/0205110 A1
(43) Pub. Date: Nov. 6, 2003

(54) Lugnut installation ring

(76) Inventor: Paul Patrick Hamernik, Winona, MN (US)

Correspondence Address: PAUL PATRICK HAMERNIK, 191 EAST KING STREET, WINONA, MN, 55987, US

(21) Appl. No.: 10/136,579

(22) Filed: May 1, 2002

(51) Int. Cl. B25B 9/00

(52) U.S. Cl. 81/13

(57) ABSTRACT

A circular cutout with precisely cut holes, it holds spare lug nuts to facilitate faster pit stops during automobile racing events. The lug nut holes match the wheel's lug holes in both diameter location and number.

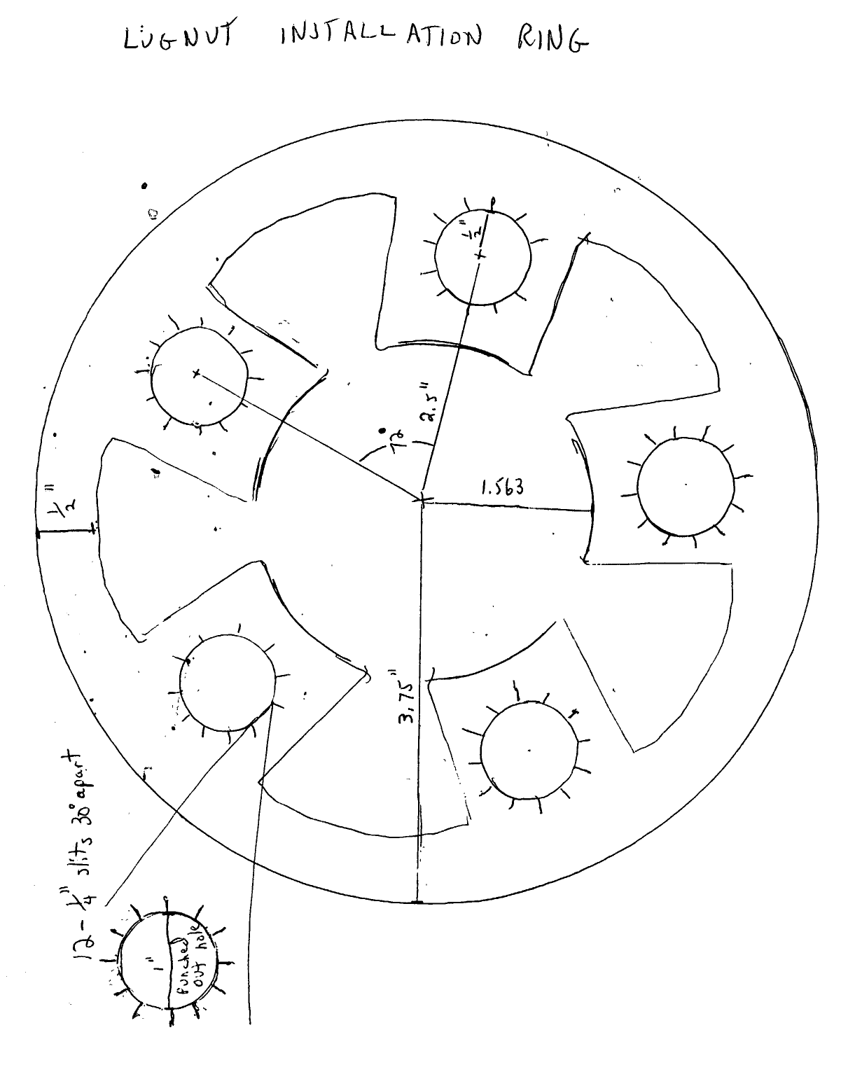

### BACKGROUND OF THE INVENTION

1. Field of invention

This invention relates in general to the changing of flat tires during racing events and in particular to a devise that allows faster lug nut replacement through the use of a rigid cut out that holds spare lug nuts in the desired circular pattern.

2. Prior art

Nothing is more frustrating to a racer than a flat tire during a racing event. Tire changing usually eliminates any chance of winning or finishing in a good paying position. To change a tire during a race , with the car supported by a jack, each lug nut is removed and the tire is changed. Now each lug nut must be picked up and individually reinstalled, tightened, off the jack and back into the race. NASCAR race teams solve this problem by gluing the lug nuts to their respective wheel, thus speeding tire changing. Lower echelon teams lack the funding and expertise to do this. Having been in racing for over 30 years, I know of no devise that allows a racer to reinstall all lug nuts at one time, until now, with the use of my invention.

### SUMMARY OF THE INVENTION

The object of this invention is to hold spare lug nuts in proper positions, thus allowing the installation of all lug nuts in one motion rather than individual motions. The invention is of simple design and inexpensive construction, and the use of this invention will allow faster flat tire changes during racing events.

### DETAILED DESCRIPTION

As shown in the drawing, my invention simulates the center of a wheel, and holds the wheel's lug nuts in the exact position to allow fast, easy installation of the lug nuts.

The invention is constructed of cardboard, or similar material, with the holes precisely located. The center hole cutout must be of sufficient diameter to fit over the wheel center hub, and the outer dimension is of sufficient diameter to support the weight of the lug nuts. The lug nut holes are cutout at the same distance and spacing as the wheel they are designed to work with. The individual lug nut holes are cut to allow easy installation of the nuts, and to allow relief for the tool that will be used to tighten the lug nuts. The exact degrees each nut are apart from each other is derived by dividing 360 degrees by the number of lug nut holes hence a 5 nut wheel would have the cutouts 72 degrees apart. The exact diameter that the lug nut holes are cutout on, matches the wheel's stud holes circular diameter. The most popular racing size being a 5 inch diameter, though other sizes are also available. Additional material is removed from the cardboard between the lug nuts, to allow flexing of the devise as a nut is tightened, so that the other lug nuts are not removed from their proper position.

1. I claim that my invention will permit installation of spare lug nuts, in one motion, during tire changes, in racing events.
